(19) United States
(12) Patent Application Publication
(10) Pub. No.: US 2026/0228292 A1
(43) Pub. Date: Aug. 6, 2026

(54) DYNAMIC PROMPT GENERATION FOR DOCUMENT INTERACTION OPERATIONS

(71) Applicant: Microsoft Technology Licensing, LLC, Redmond, WA (US)

(72) Inventor: Sarah Ragab Ismail SALEH, Vancouver (CA)

(73) Assignee: Microsoft Technology Licensing, LLC, Redmond, WA (US)

(21) Appl. No.: 19/045,418

(22) Filed: Feb. 4, 2025

(51) Int. Cl. G06F 16/9535; G06F 3/04842; G06F 3/04845; G06F 16/34; G06F 40/166

(52) U.S. Cl. CPC G06F 16/9535; G06F 3/04842; G06F 3/04845; G06F 16/345; G06F 40/166

(57) ABSTRACT

A method for dynamic prompt generation includes receiving document content data representing a digital document accessed during a document access session. One or more document context parameters are received relating to a context of the document access session. A current prompt domain is determined that pertains to the document access session. From a prompt generation system, one or more candidate prompts are received, specifying one or more respective machine learning (ML)-mediated document interaction operations that could be applied to the digital document. The one or more candidate prompts are generated based at least in part on the document content data, the one or more document context parameters, and the current prompt domain. The one or more candidate prompts are displayed in a user interface (UI). A user selection of a selected prompt is received, and the ML-mediated document interaction operations associated with the selected prompt are applied.

### BACKGROUND

Machine learning models have demonstrated significant utility in generating text and other digital content based on user-provided prompts. These models are widely used in applications such as content creation, automated translation, and conversational systems. By leveraging contextual inputs, such systems can provide relevant and coherent outputs across diverse domains.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for dynamic prompt generation includes receiving document content data representing a digital document accessed during a document access session. One or more document context parameters are received relating to a context of the document access session. A current prompt domain is determined that pertains to the document access session. From a prompt generation system, one or more candidate prompts are received, specifying one or more respective machine learning (ML)-mediated document interaction operations that could be applied to the digital document. The one or more candidate prompts are generated based at least in part on the document content data, the one or more document context parameters, and the current prompt domain. The one or more candidate prompts are displayed in a user interface (UI). A user selection of a selected prompt is received, and the ML-mediated document interaction operations associated with the selected prompt are applied.

### BRIEF DESCRIPTION OF THE DRAWINGS

FIGS. 1A, 1B, and 1C schematically illustrate the use of a prompt generation system to generate candidate prompts for interacting with a digital document.

FIG. 2 illustrates an example method for dynamic prompt generation.

FIGS. 3A-3H schematically illustrate an example user interface (UI) that facilitates display and selection of candidate prompts for interacting with a digital document.

FIGS. 4A-4D schematically illustrate example processes through which a machine learning model is configured to output candidate prompts.

FIG. 5 schematically shows an example computing system.

### DETAILED DESCRIPTION

Interacting with digital documents often involves a variety of tasks that can be time-consuming and labor-intensive, particularly when users need to create, review, or derive insights from document content. Tasks such as generating new content, revising existing text, or summarizing information received from others may require significant effort and can be slowed by the manual processes traditionally employed. These challenges are amplified in environments where users must perform such tasks repeatedly or across multiple documents.

Accordingly, the present disclosure describes techniques for dynamically generating prompts that, when input to a machine learning (ML) model, result in one or more ML-mediated document interaction operations being applied to a digital document. In this manner, the techniques described herein may streamline various document interaction tasks by leveraging ML models to suggest different operations that the system could automatically apply to a document that a user is viewing. In response to user selection of one of the suggested prompts, then the corresponding operations may be automatically applied. More specifically, according to the techniques described herein, a prompt generation system receives document content data corresponding to at least a portion of a digital document accessed during a user session on a client computing device. The prompt generation system may implement one or more ML models as will be described in more detail below. Additionally, the prompt generation system receives one or more document context parameters that define the context under which the document is being accessed, as well as a current prompt domain that specifies the types of prompts that the user is currently interested in. The current prompt domain is selected from multiple predefined domains —e.g., a “Create” domain associated with creation of new content, a “Review” domain associated with reviewing or revising existing content, and/or an “Insight” domain associated with summarizing existing content.

Using the document content data, context parameters, and the current prompt domain, the prompt generation system generates candidate prompts specifying ML-mediated operations that can assist with various types of document interactions. This can include, for instance, writing or revising text, providing suggestions for modifying text, generating images and/or other digital content, summarizing text, etc. These candidate prompts are displayed in the user interface of the client computing device, allowing the user to select an operation suited to their needs. Once selected, the system applies the corresponding ML-mediated interaction operations to the document, significantly accelerating tasks such as content creation, review, and insight generation.

In this manner, the techniques described herein provide significant technical benefits by integrating machine learning models and contextual analysis to improve user interaction with digital documents. By dynamically generating prompts based on document content, context parameters, and a determined prompt domain, the system enhances the efficiency and accuracy of document-related tasks. This approach reduces the computational overhead associated with redundant or irrelevant operations by narrowing the scope of suggested actions to those most pertinent to the user's current context. Furthermore, the automated generation and application of machine learning-mediated operations reduce the need for extensive user input, allowing for faster and more streamlined workflows.

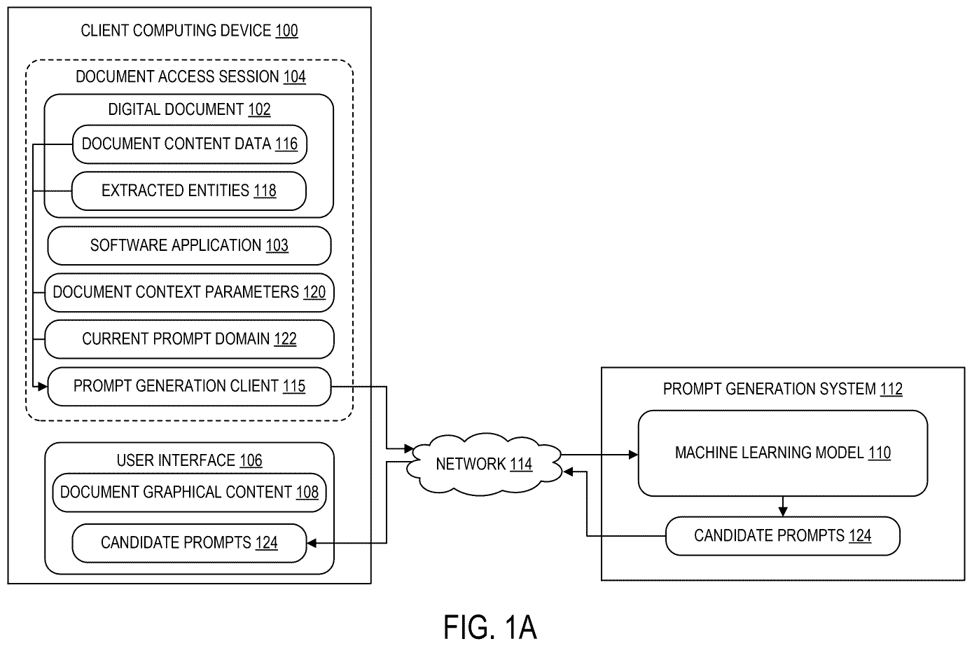

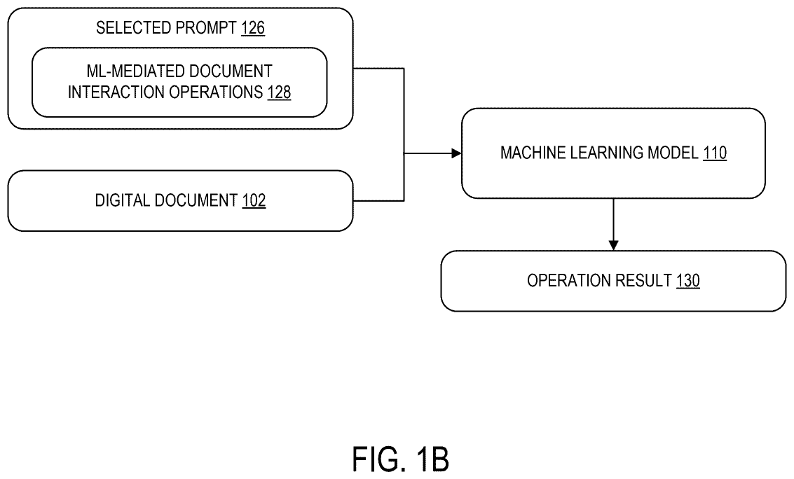

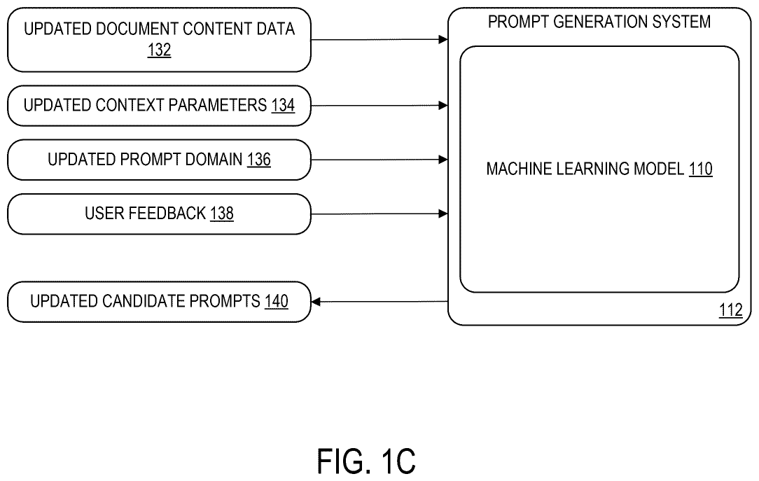

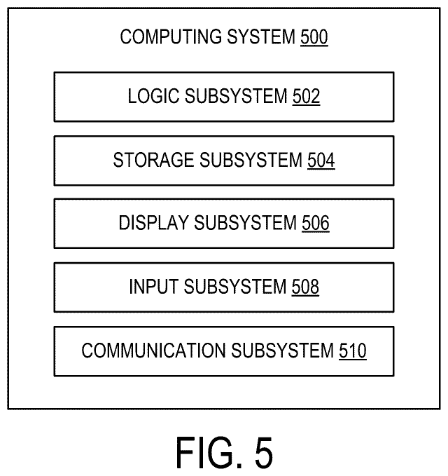

The generation of prompts for interacting with a digital document is schematically illustrated with respect to FIGS. 1A and 1B. Specifically, FIG. 1A schematically shows an example client computing device 100. In general, this may take the form of any suitable computing device, having any suitable capabilities, hardware configuration, and form factor. As non-limiting examples, a client computing device may refer to a personal computer (e.g., laptop, desktop computer), mobile computing device (e.g., smartphone, tablet), mixed reality computing device, wearable computing device, etc. In some examples, client computing device 100 may be implemented by computing system 500 described below with respect to FIG. 5.

In FIG. 1A, the client computing device is being used to access a digital document 102. As used herein, the term “digital document” refers to any electronic file, representation, or dataset comprising structured, semi-structured, or unstructured content that can be displayed, edited, or otherwise manipulated by a computing device. In some examples described herein, the digital document is a text-based document accessed via a word processing application, although this is non-limiting. A digital document may include, but is not limited to, text-based documents, spreadsheets, presentations, graphical content, multimedia files, or any combination thereof, and may be stored in various file formats or accessed via a networked environment. In FIG. 1A, the digital document has been opened for review by a software application 103, which may take any suitable form depending on the implementation—e.g., any suitable application for viewing and/or editing digital documents. For instance, in cases where the digital document is a text-based document, then the software application may take the form of a word processing application. In other cases, the software application may take other suitable forms, such as other text editing applications, spreadsheet applications, note-taking applications, multimedia applications, messaging applications, etc.

Furthermore, according to the present disclosure, the digital document is accessed during a “document access session.” This is represented in FIG. 1A as document access session 104. As used herein, the term “document access session” refers to a period during which a user interacts with a digital document via a client computing device. A document access session may encompass activities such as viewing, editing, reviewing, annotating, and/or performing other suitable operations with respect to the digital document, and may be defined by continuous or intermittent interactions with the document. In general, during a document access session, the computing device loads data associated with the digital document from computer storage (e.g., from local storage, from removable storage, from a network location), and renders the data such that the contents of the digital document can be reviewed by a human user.

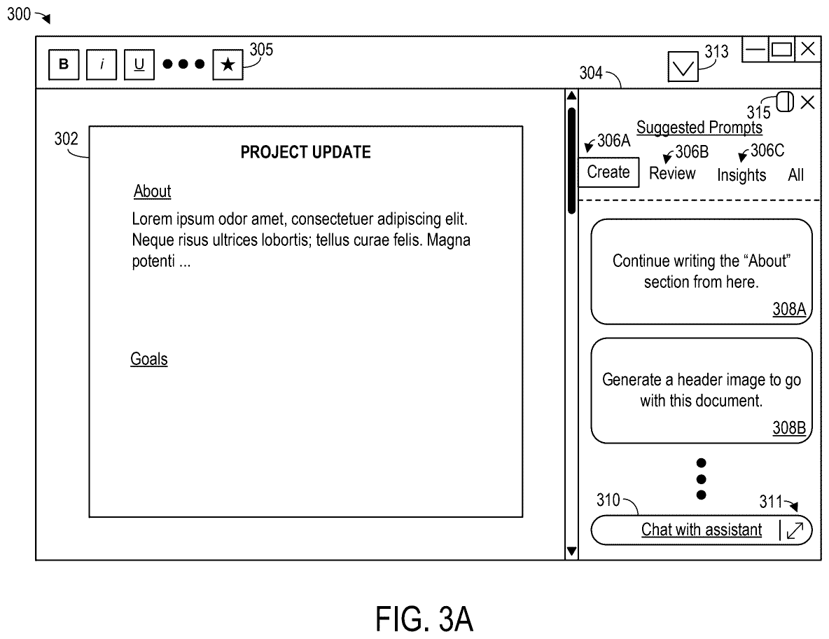

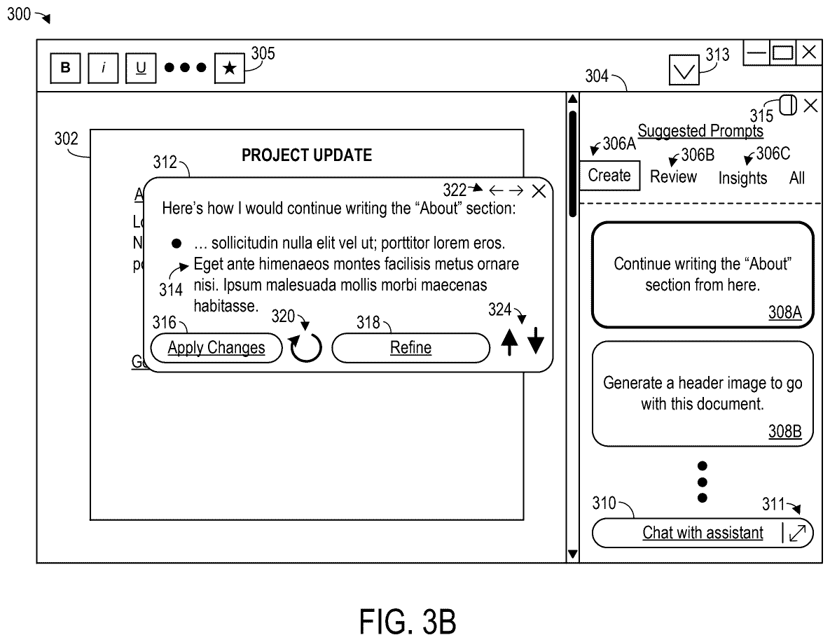

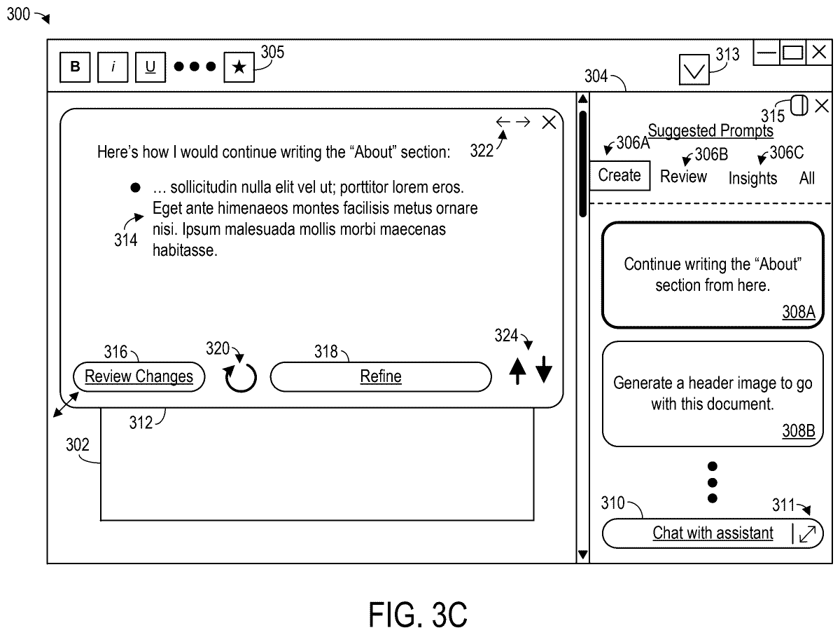

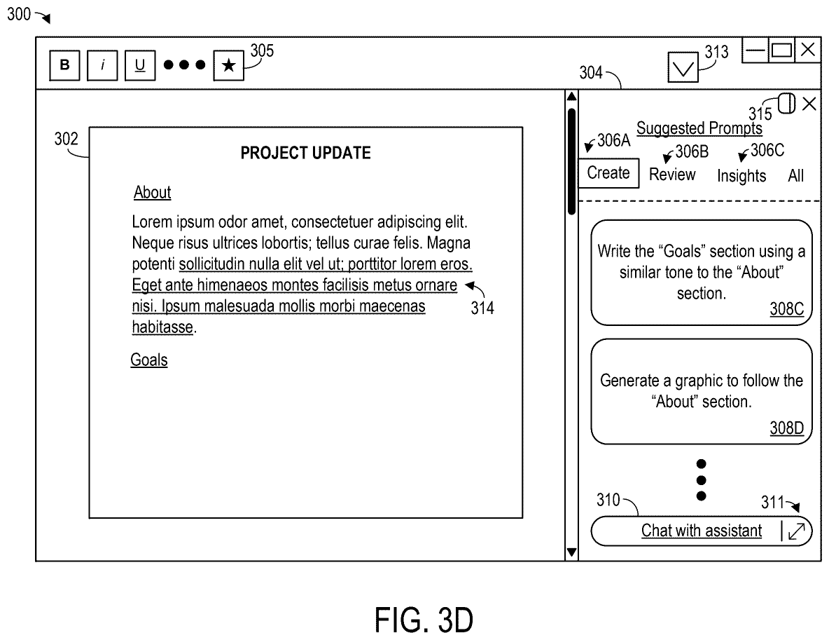

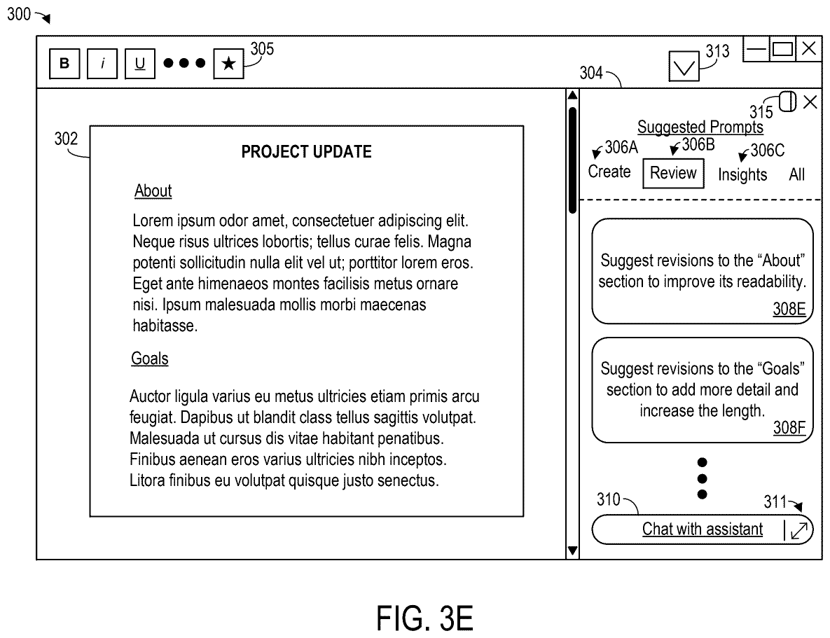

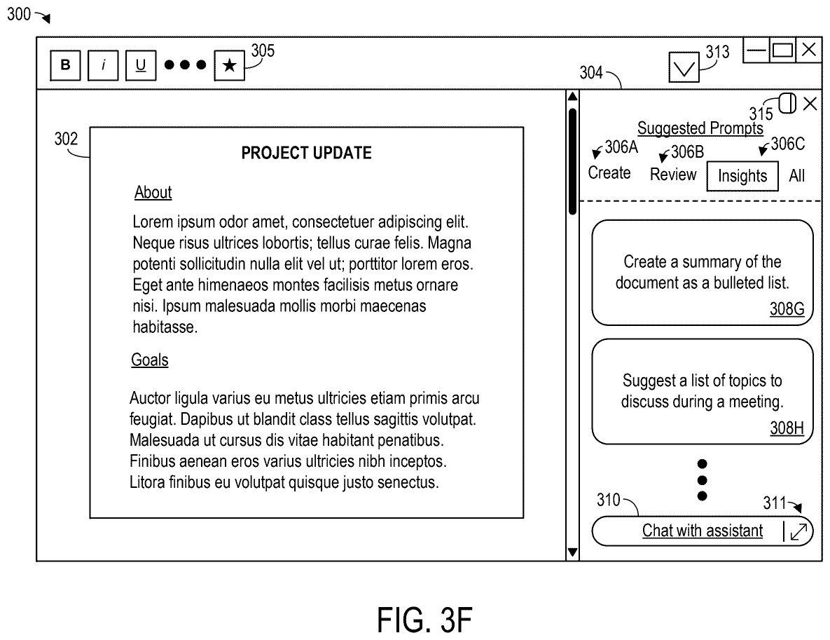

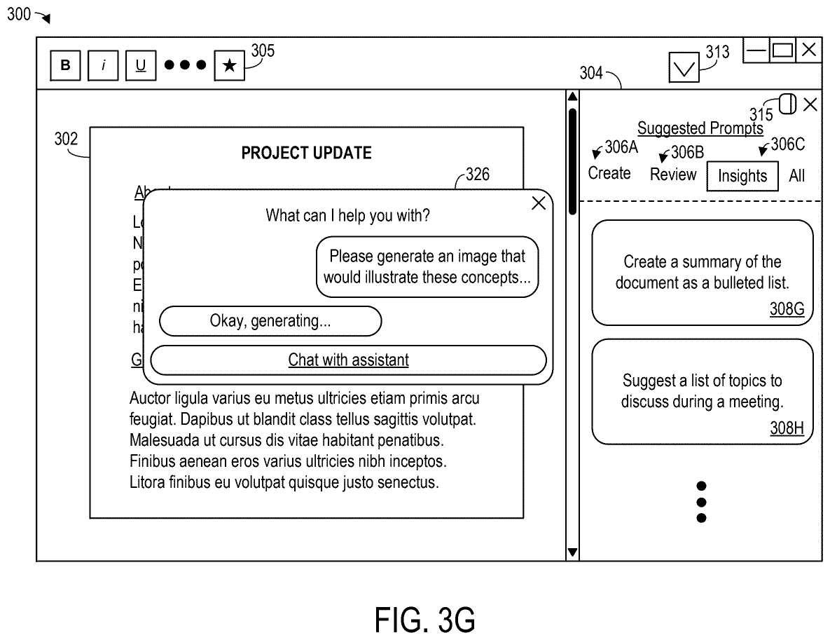

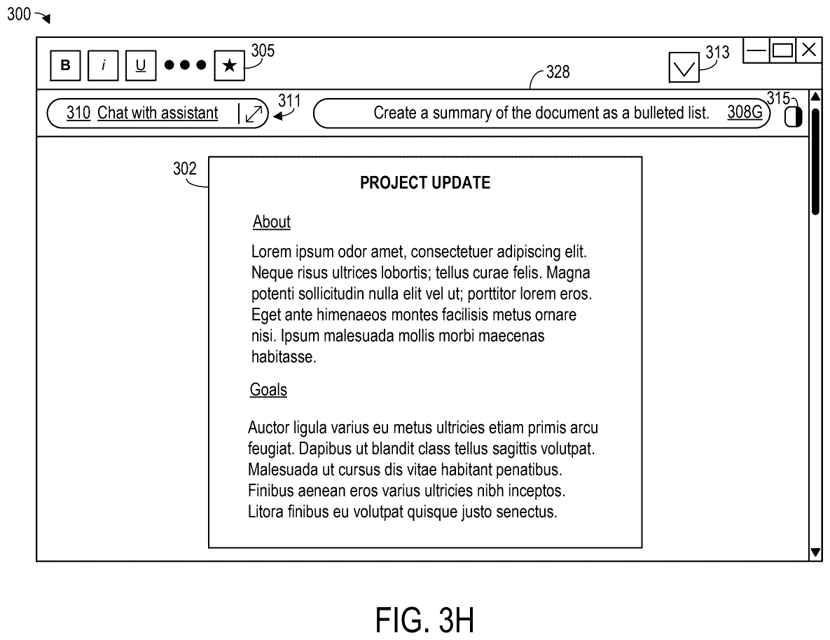

In the example of FIG. 1A, such reviewing is facilitated by a user interface (UI) of the client computing device, which includes graphical content 108 corresponding to the digital document. This may, for instance, include text, images, videos, diagrams, spreadsheet cells, and/or any other suitable graphical representations of the digital document's contents. The UI may additionally include any other suitable graphical content—e.g., including UI elements corresponding to a software application used to review the digital document (such as a word processing application or internet browser), UI elements corresponding to other software applications of the client computing device, UI elements corresponding to an operating system (OS) of the client computing device, etc. One example UI will be described below with respect to FIGS. 3A-3F.

As discussed above, during the document access session, one or more ML models may be used to dynamically generate prompts specifying different ML-mediated document interaction operations that could be applied to the digital document. Non-limiting examples of ML-mediated document interaction operations may include generating new text based on user-defined prompts or keywords, such as drafting a paragraph or writing a summary; expanding or refining existing content, such as elaborating on a brief idea or rephrasing for improved clarity; identifying and correcting grammatical or typographical errors; recommending edits to improve readability or adherence to a specific tone or style; detecting inconsistencies within a document, such as mismatched terms or formatting discrepancies; summarizing key points from a document for quick review; extracting specific information (e.g., names, dates, or figures) based on user-defined criteria; generating sentiment analyses of text; detecting overlapping edits by multiple collaborators and proposing resolutions; offering contextual comments or recommendations tailored to document collaborators; identifying related documents or reference materials; suggesting hyperlinks or citations; reorganizing sections of a document to improve flow; applying consistent formatting styles; creating tables, charts, or bullet lists based on structured or semi-structured content; generating images or other graphical content for inclusion in the digital document; generating notes or correspondence (e.g., emails) based on the digital document, etc. It will be understood that these examples are not exhaustive, and that ML-mediated interaction operations may refer to any of a wide variety of different types of interactions that could be automatically applied to, or based on, a digital document.

In the example of FIG. 1A, such prompts are dynamically generated by an ML model 110 based on data pertaining to the digital document. The prompts generated by the ML model are referred to herein as “candidate prompts,” as they are presented to a user as part of the UI for potential selection, as will be described in more detail below. ML model 110, and/or any other ML models used to implement the techniques described herein, may be implemented using any suitable underlying ML and/or artificial intelligence (AI) technologies. Non-limiting examples of suitable ML and/or AI technologies will be described below with respect to FIG. 5.

In some examples, ML model 110 may be trained from scratch to generate candidate prompts as described herein. For instance, the ML model may be trained with training data that includes various types of digital documents, contextual data relating to the documents, and user-provided prompts that would be applicable in the scenarios reflected by the training data. Additionally, or alternatively, the ML model may be implemented through custom instructions, tuning, and/or other modifications applied to an existing trained model, such as a general-purpose language generation model.

The ML model 110 is implemented by a prompt generation system 112 communicatively coupled with the client computing device via a computer network 114. In other words, in this example, the prompt generation system is implemented by a server computer system, and the client and server communicate with one another via the Internet. It will be understood, however, that this scenario is non-limiting. For instance, a client computing device may communicate with a prompt generation system over another suitable computer network, such as a local area network. Additionally, or alternatively, the prompt generation system may be at least partially implemented by the client computing device itself. In other words, in some examples, the ML model 110 may be a local model that is executed by the client computing device, rather than executed by a separate server computer.

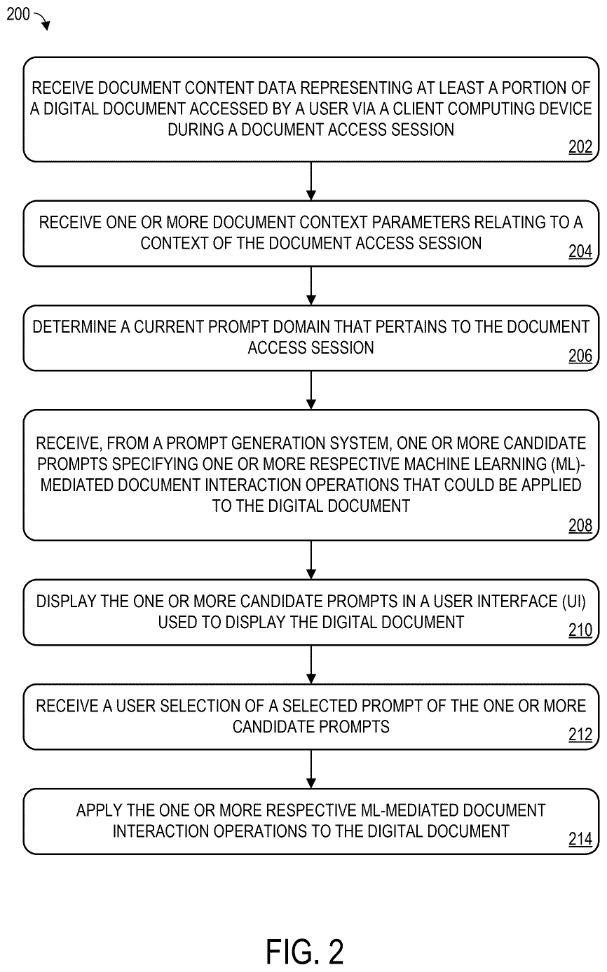

Regardless, the ML model receives various types of data pertaining to the digital document and thereby generates candidate prompts specifying ML-mediated interaction operations that could be applied to the digital document. To this end, FIG. 2 illustrates an example method 200 for dynamic prompt generation. Steps of method 200 may be initiated, terminated, and/or repeated at any suitable time and in response to any suitable condition. Method 200 may be implemented by any suitable computing system of one or more computing devices. Any computing device implementing steps of method 200 may have any suitable capabilities, hardware configuration, and form factor. As one non-limiting example, method 200 may be implemented by computing system 500 described below with respect to FIG. 5.

With reference to FIG. 1A, steps of method 200 will be described with respect to a prompt generation client 115 of the client computing device. This takes the form of one or more software functions implemented by the client computing device configured to receive various types of data pertaining to the digital document and pass the pertinent data to the prompt generation system. In this example, the prompt generation client transmits the data over the computer network to the remote prompt generation system implemented via a server, as discussed above. However, it will be understood that, in other examples, the prompt generation client may pass the data to a prompt generation system implemented by the client computing device itself—e.g., via local execution of one or more ML models. The prompt generation client may in some cases be implemented as part of the software application used to review the digital document. Additionally, or alternatively, aspects of the prompt generation client may be implemented by other software applications and/or the operating system of the client computing device.

At 202, method 200 includes receiving document content data representing at least a portion of a digital document accessed by a user via a client computing device during a document access session. In FIG. 1A, the prompt generation client receives document content data 116. As used herein, the term “document content data” refers to any information or data representing the content of a digital document, including but not limited to text, images, tables, metadata, or embedded multimedia. Document content data may encompass structured, semi-structured, or unstructured data, and can be derived from various sources, including the document's visible elements, underlying code, or associated metadata. In some examples, the document content data may represent the entire digital document. In other examples, the document content data may represent only a portion of the digital document—e.g., a portion currently visible to the user via the UI.

As a more specific example, the document content data may reference one or more entities that are identified within and extracted from the digital document. In the example of FIG. 1A, the digital document includes a plurality of extracted entities 118. As non-limiting examples, “entities” may include names, dates, times, places, keywords, headings, titles, labels, section headers, etc., within the digital document, and the ML-mediated interaction operations may be generated based at least in part on the extracted entities. For instance, in one non-limiting example, the entities may include column and/or row labels from a spreadsheet, and one or more of the candidate prompts generated by the prompt generation system may specify ML-mediated interaction operations that change the column and/or row labels.

Returning briefly to FIG. 2, at 204, method 200 includes receiving one or more document context parameters relating to a context of the document access session. In FIG. 1A, the prompt generation client additionally receives document context parameters 120 associated with the document access session 104. As used herein, the term “document context parameters” refers to information or data that characterizes the context in which a digital document is accessed, displayed, or interacted with during a document access session. Document context parameters may include, but are not limited to, user interaction data (e.g., navigation patterns, edits, or input commands), session-specific metadata (e.g., timestamps or access privileges), and environmental variables (e.g., the type of device or software application used). These parameters provide situational context for tailoring operations or prompts relevant to the document. More particularly, as non-limiting examples, the document context parameters may include any or all of a current cursor position within the digital document (e.g., hovering over selected text, hovering over an image, positioned near a UI element), a current selected tool (e.g., a text editing tool, a highlighting tool, a line drawing tool), selected content within the digital document (e.g., a selected text passage), a current user viewport in the UI, an edit history of the digital document, access permissions associated with the user, a history of previous candidate prompts selected for the digital document, a history of previous edits applied by other users, a history of candidate prompts selected by other users, etc. It will be understood that these examples are not exhaustive, and that document context parameters may include any of a wide variety of different types of data relating to the context under which a document is accessed, depending on the implementation.

Returning briefly to FIG. 2, at 206, method 200 includes determining a current prompt domain that pertains to the document access session. In the example of FIG. 1A, the prompt generation client receives a current prompt domain 122 pertaining to the document access session. A “prompt domain” refers to the types of prompts that the user is currently interested in being suggested, and/or that the system determines would be appropriate given the current document and document context. In other words, there are two or more different prompt domains associated with different types of candidate prompts that can be generated by the prompt generation system, and the current prompt domain is selected from among those two or more options. As one non-limiting example, these different prompt domains may include a first prompt domain associated with generation of new content for inclusion in the digital document (e.g., a “Create” domain), a second prompt domain associated with modification of existing content in the digital document (e.g., a “Review” domain), and a third prompt domain associated with summarizing the existing content of the digital document (e.g., an “Insight” domain).

The current prompt domain may be determined in any suitable way. As will be described in more detail below, in some examples, the UI may include two or more segmented controls (and/or other suitable UI controls) corresponding to the two or more different prompt domains. The user may thereby select the current prompt domain through user selection of the corresponding segmented UI control. Additionally, or alternatively, in some cases, the current prompt domain may be automatically determined based at least in part on the document content data and the one or more document context parameters. For instance, in one example scenario where the user has started with a blank document and begun composing text, the system may infer from the document content data and the document context parameters that the user is in the process of generating new content for the digital document, and thus automatically select a “Create” prompt domain.

Returning briefly to FIG. 2, at 208, method 200 includes receiving, from the prompt generation system, one or more candidate prompts specifying one or more respective machine learning (ML)-mediated document interaction operations that could be applied to the digital document during the document access session. The one or more candidate prompts are generated based at least in part on the document content data, the one or more document context parameters, and the current prompt domain. In the example of FIG. 1A, the document content data 116, document context parameters 120, and current prompt domain 122 are transmitted to the prompt generation system 112, which uses ML model 110 to generate a set of candidate prompts 124. These are then transmitted back to the client computing device for presentation to the user.

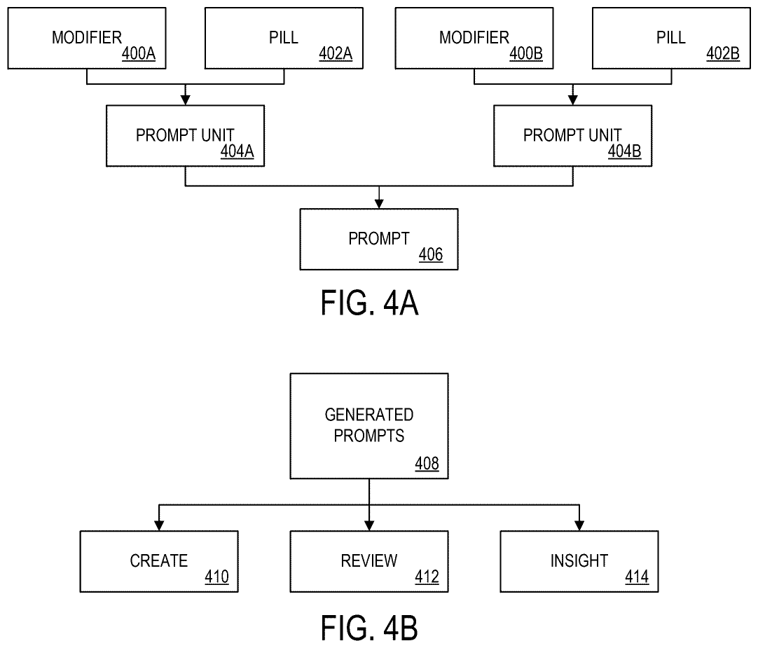

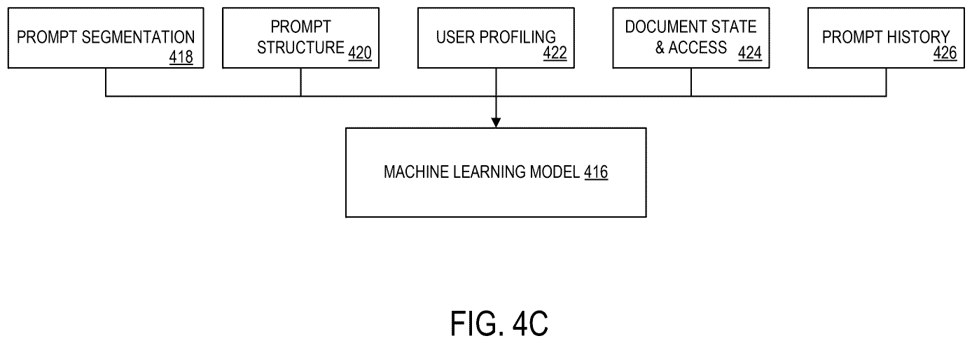

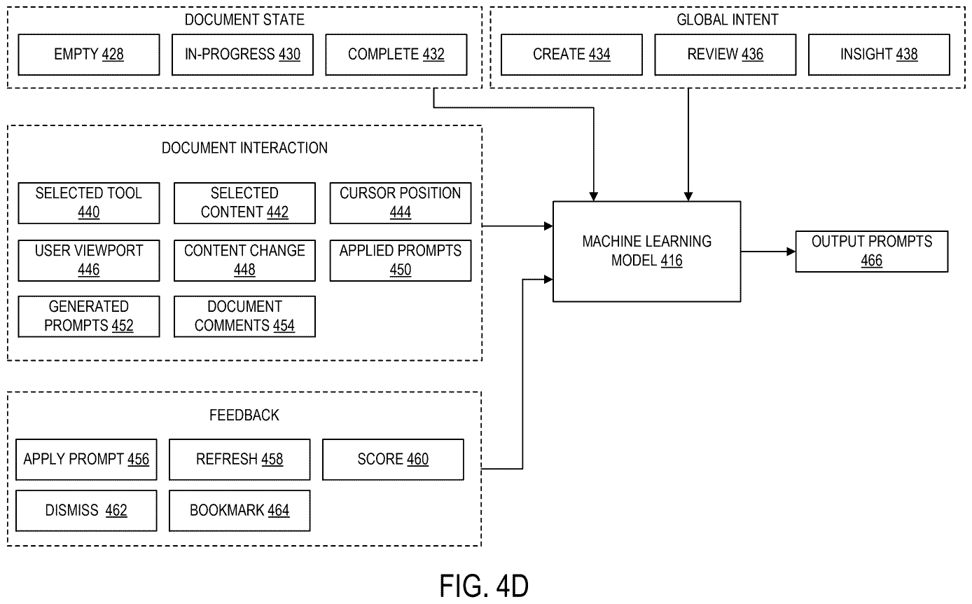

The candidate prompts may be generated by the ML model in any suitable way. As discussed above, the ML model may be implemented using any suitable underlying ML and/or AI technology and may be trained to generate candidate prompts using any suitable training and/or model adaptation techniques. In some scenarios, the ML model may implement a prompt abstraction, scoring, and tagging process which is applied to prior prompts generated by the ML model. This may serve to improve the accuracy and relevance of future prompts generated by the ML model. These will be described in more detail below with respect to FIGS. 4A-4D.

In some examples, prompts may be generated using a “pill and modifier” model. For instance, a prompt “pill” may specify the baseline instruction for the model, such as “generate text for expanding this section of the document,” while a modifier may provide more detailed instructions for fine-tuning the system's response, such as “make it sound concise and professional.” A pill and a modifier together may constitute a “prompt unit,” and a candidate prompt may include one or more different prompt units. This will be described in more detail below with respect to FIG. 4B.

Returning briefly to FIG. 2, at 210, method 200 includes displaying the one or more candidate prompts in a UI used to display the digital document at the client computing device. In the example of FIG. 1A, the candidate prompts 124 are displayed in UI 106 along with the graphical content 108 of the digital document. Display of candidate prompts will be described in more detail below with respect to a non-limiting user interface shown in FIGS. 3A-3H.

Returning briefly to FIG. 2, at 212, method 200 includes receiving a user selection of a selected prompt of the one or more candidate prompts. At 214, the method includes applying the one or more respective ML-mediated document interaction operations associated with the selected prompt to the digital document. This is schematically illustrated with respect to FIG. 1B, in which a user has selected one of the candidate prompts 124 from FIG. 1A as a selected prompt 126. As discussed above, the selected prompt specifies one or more ML-mediated document interaction operations 128, which the user would like applied to the digital document 102. As shown, the ML model 110 uses the selected prompt to apply the corresponding ML-mediated document interaction operations 128 to the digital document 102 to produce an operation result 130. This may take any suitable form depending on the candidate prompt that was selected. For instance, the operation result may be new content for inclusion in the digital document (e.g., generated text and/or images), a modified form of the digital document (e.g., in which existing content of the document has been changed), and/or new content generated based on the digital document (e.g., notes, outlines, email drafts, etc., summarizing the document).

In the example of FIG. 1B, the same ML model 110 is used for applying the selected prompt to the digital document as was previously used to generate the set of candidate prompts presented to the user. It will be understood, however, that this need not be the case. For instance, in other examples, separate ML models may be used for generating sets of candidate prompts pertaining to a digital document and applying selected prompts to perform ML-mediated document interaction operations to the digital document.

In some examples, the document content data and/or the document context parameters may change over time. This may include, for instance, the user making changes to the digital document, and/or selecting generated prompts that cause corresponding ML-mediated interaction operations to be applied to the digital document. As such, in some examples, the prompt generation system may dynamically generate updated candidate prompts as the document content data changes and/or as the document context parameters change. In other words, the client computing device may receive, from the prompt generation system, one or more updated candidate prompts that are generated as the document content data changes during the document access session.

Additionally, or alternatively, updated candidate prompts may be generated in response to other suitable changes in data. For instance, during a document access session, the current prompt domain may change—e.g., due to user selection of a different UI element, and/or via the system automatically determining that the user has begun interacting with the document in a different manner that is consistent with a different prompt domain. Similarly, in some scenarios, users may provide feedback to candidate prompts that are generated by the prompt generation system and displayed for user review. For instance, as will be described below with respect to FIGS. 3A-3H, in some scenarios, the UI may include one or more UI elements useable for users to give positive or negative feedback to the candidate prompts generated by the system. As such, in some examples, the system may receive user feedback directed at one or more candidate prompts. The client computing device may then receive a second set of candidate prompts from the prompt generation system, which are generated based at least in part on the user feedback.

These scenarios are schematically illustrated with respect to FIG. 1C, again showing prompt generation system 112 implementing ML model 110. As shown, in this example, the prompt generation system receives updated document content data 132, updated context parameters 134, an updated prompt domain 136, and user feedback 138 directed at one or more of the previously generated candidate prompts. In response, the prompt generation system generates an updated set of one or more candidate prompts 140, which similarly may be displayed for user review and possible selection to apply ML-mediated interaction operations to the digital document.

Display and selection of candidate prompts will now be described in more detail with respect to FIGS. 3A-3H. Specifically, FIG. 3A shows a simplified example UI 300 that may be used to facilitate the display and selection of candidate prompts, as discussed above. UI 300 may be rendered and displayed by any suitable computing device, such as client computing device 100 of FIG. 1A or computing system 500 described below with respect to FIG. 5. It will be understood that UI 300 is highly simplified and provided only as one non-limiting example. Thus, the specific appearance and arrangement of the different UI elements shown as part of UI 300 is non-limiting and may vary depending on the implementation.

As shown, UI 300 is used to display graphical content of a digital document 302. In this simplified example, the digital document takes the form of a text document titled “Project Update,” which includes an “About” heading, a “Goals” heading, as well as generic placeholder text included for the sake of explanation. The UI additionally includes various UI elements useable to interact with the digital document, and select and apply candidate prompts generated by a prompt generation system.

Specifically, UI 300 includes a prompt display portion 304, which in this example, takes the form of an interface pane positioned on the right-hand side of the UI. In some scenarios, the prompt display portion may be dynamically toggleable during review of the digital document. For instance, UI 300 includes an example toolbar control 305 that, when selected, causes display of the prompt display portion. In other words, selection of the toolbar control 305 may change the layout of the UI and cause the prompt display portion to appear. Subsequent selection of the toolbar control may similarly hide the prompt display portion, in some examples. In cases where the prompt display portion is not shown, then functionality of the prompt display portion may in some cases be integrated into other portions of the UI—e.g., such as in the toolbar along with toolbar control 305. Additionally, or alternatively, the prompt display portion may be displayed in response to selection of other suitable UI elements (e.g., from an in-line UI control shown in the body of the digital document, or from a context menu, such as a right-click context menu, etc.).

Additionally, in FIG. 3A, the prompt display portion includes various segmented controls corresponding to different prompt domains. Specifically, as shown, the UI includes segmented controls 306A, 306B, and 306C, respectively corresponding to “Create,” “Review,” and “Insight” prompt domains as discussed above. Additionally, in this example, the UI includes an “All” segmented control, which may be used to show candidate prompts from any of the different prompt domain options. Notably, each of the segmented controls is associated with a different UI section of the prompt display portion. Selection of one of the segmented controls causes display of corresponding candidate prompts in the UI section associated with the selected segmented control. In this example, the “Create” prompt domain is selected, which causes display of corresponding candidate prompts 308A and 308B in the prompt display portion. In other scenarios, as will be described below, selection of one of the other segmented controls, corresponding to different prompt domains, may switch to a different UI section within the prompt display portion that includes a different subset of candidate prompts that are specific to the selected prompt domain.

In FIG. 3A, because the “Create” prompt domain is selected, the example candidate prompts 308A and 308B are each associated with creation of new content for inclusion in the digital document. For instance, candidate prompt 308A specifies ML-mediated interaction operations that include generation of additional text for inclusion in the “About” section. In this manner, the candidate prompt references a specific entity (e.g., the “About”) section that is extracted from the digital document. The other candidate prompt 308B shown in FIG. 3A specifies ML-mediated interaction operations that include generation of a header image to accompany the digital document. As will be discussed in more detail below, user selection of either of these candidate prompts may cause the selected prompt to be input to an ML model, which applies the corresponding ML-mediated interaction operations to the digital document.

In some examples, the user may have additional options for interacting with the ML model besides selection of candidate prompts. For instance, UI 300 includes a chat interface 310, which enables the user to provide natural language inputs to the ML model. In this manner, the user may directly specify the types of ML-mediated interaction operations that they would like to have applied, even if such operations are not currently reflected in the set of generated candidate prompts. Additionally, or alternatively, the user may provide feedback or instructions for refining the set of candidate prompts that the system has generated.

In some examples, the chat interface may be expanded to a floating chat window. For instance, in FIG. 3A, the chat interface includes an expansion control 311. User selection of the expansion control may cause the system to display a separate chat window that is at least partially overlaid on the graphical document contents. This will be illustrated and described below with respect to FIG. 3G.

Turning now to FIG. 3B, the user has selected candidate prompt 308A to be applied to the digital document. This has caused display of a prompt-specific interface window 312 in the UI. In this example, the prompt-specific interface window partially overlaps the graphical content of the digital document. However, it will be understood that the prompt-specific interface window may have other suitable positions with respect to the UI. Furthermore, in some examples, the size and position of the prompt-specific interface window may be dynamically adjustable. As shown, the prompt-specific interface window includes visual content 314 related to application of the one or more respective ML-mediated document interaction operations to the digital document. In this example, this includes text 314 that was generated for inclusion in the digital document—e.g., for continuing the “About” section, as was specified by the selected candidate prompt.

In this example, the candidate prompt was displayed in, and selected from, the prompt display portion 304, which is implemented as a separate interface pane that is displayed to the right of the document content. In other examples, the prompt display portion may have other suitable positions and appearances. For instance, in some examples, a minimized form of the prompt display portion may be rendered as a toolbar that is displayed above the document contents. Interface 300 additionally includes a minimized view control 313. User selection of the minimized view control may cause display of a prompt display portion taking the form of a toolbar. This will be illustrated and described below with respect to FIG. 3H. Additionally, in FIG. 3A, the UI includes a toggle control 315. Selection of the toggle control may dynamically toggle between the panel-style prompt display portion, and the toolbar-style prompt display portion.

In FIG. 3B, the prompt-specific interface window additionally includes various UI elements that can be used for accepting, rejecting, or modifying the proposed changes. For instance, an application UI element 316 can be used to apply the ML-mediated interaction operations to the digital document—e.g., by adding the generated text to the document. A refining UI element 318 may be used to provide feedback to the prompt generation system—e.g., the user may provide natural language instructions for modifying or replacing the text generated by the system. Similarly, a regeneration UI element 320 may be selected to cause the ML model to regenerate its response to the same selected prompt. In this manner, multiple different responses to the same prompt may be generated. The user may toggle between these different responses using response history UI elements 322—e.g., to go back to a previous response generated by the system that the user preferred. Additionally, in this example, the prompt-specific interface window includes feedback UI elements 324 useable to provide positive or negative feedback in response to the content generated based on the selected prompt. Such feedback may be considered by the prompt generation system when generating updated candidate prompts, as discussed above.

As discussed above, in some examples, the size and/or position of the prompt-specific interface window may be dynamically adjustable. This is illustrated with respect to FIG. 3C, in which both the size and position of the prompt-specific interface window has been changed. Specifically, as shown, the user has provided input causing an increase in size of the prompt-specific interface window, and the user has also moved the prompt-specific interface window relative to other portions of the UI. This has caused corresponding changes of the content and various UI elements within the prompt-specific interface window based on the window's updated size.

Turning now to FIG. 3D, the user has selected the application UI element 316 to apply the ML-mediated document interaction operations to the digital document. This has caused the visual content 314 previously shown in the prompt-specific interface window to be added to the “About” section of the digital document, as specified by the selected prompt. In the example of FIG. 3D, the newly-added text is shown in underline, which may enable the user to more easily distinguish the changes that were applied as a result of their interaction with the prompt-specific interface window. Additionally, this has resulted in changes to the document content data and document context parameters, as discussed above. The prompt generation system has therefore generated updated candidate prompts 308C and 308D, each still associated with the “Create” domain. Specifically, candidate prompt 308C instructs the system to generate text for the “Goals” section of the document using a similar tone to the “About” section, and the candidate prompt 308D instructs the system to generate a graphic to follow the “About” section.

FIG. 3E depicts a scenario where additional text has been added to the digital document (e.g., through manual writing by the user and/or via automated text generation by the ML model), and thus the user may consider the document to be “complete.” As such, the user has selected a different segmented control 306B of the UI, corresponding to the “Review” prompt domain, which is associated with modification of existing content in the digital document. As a result, the prompt generation system has generated updated candidate prompts 308E and 308F that are specific to the updated prompt domain. Specifically, each of these new candidate prompts relate to suggesting revisions to the existing content of the digital document, rather than generating new content for inclusion in the digital document. These may be useful to the same user who originally drafted the digital document, and/or to other users who may be reviewing the digital document after it is drafted (e.g., a manager or a customer).

Similarly, in FIG. 3F, the user has selected segmented control 306C, corresponding to the “Insight” prompt domain, which is associated with summarizing the existing content of the digital document. Accordingly, the prompt generation system has generated updated candidate prompts 308G and 308H. Each of these are directed to summarizing and/or extracting information from the contents of the digital document, rather than modifying the digital document itself. These may be useful to users who have received the digital document after it was created by someone else e.g., enabling the users to more quickly understand and discuss the digital document without spending significant time and energy performing a manual review of the document's contents.

FIG. 3G illustrates a scenario in which a user has selected the expansion control 311. This has caused the system to discontinue display of the chat interface 310 within the prompt display portion 304. Instead, the system has rendered a floating chat window 326, which the user may use to communicate with a virtual assistant and review the assistant's responses. Though not explicitly shown in FIG. 3G, the floating chat window may additionally include controls for regenerating the system's responses, providing feedback (e.g., up-votes or down-votes) on the system's responses, reviewing the history of previous responses, etc. Furthermore, as with the prompt-specific windows described above, the size and/or position of the floating chat window may in some cases by dynamically adjustable.

FIG. 3H illustrates a scenario in which the minimized view control 313 has been selected, or the toggle control 315 has been selected. In this scenario, the prompt display portion 304 is no longer displayed. Instead, an alternative prompt display portion 328 is now shown as a toolbar above the document contents. As shown, the prompt display portion 328 still includes the chat interface 310 and expansion control 311. User selection of the expansion control 311 may cause display of a floating chat window, such as window 326 described above with respect to FIG. 3G. Additionally, the prompt display portion displays candidate prompt 308G. Though not explicitly shown in FIG. 3H, the prompt display portion 328 may include controls for changing the current prompt domain, and thus changing the candidate prompts that are shown for selection.

FIGS. 4A-4D schematically illustrate example concepts for candidate prompt structuring, segmentation, and generation. With respect to FIG. 4A, as discussed above, the generated prompts may in some cases be generated using a “pill and modifier” model. For instance, a prompt “pill” may specify the baseline instruction for the model, such as “generate text for expanding this section of the document,” while a modifier may provide more detailed instructions for fine-tuning the system's response, such as “make it sound concise and professional.” A pill and a modifier together may constitute a “prompt unit,” and a candidate prompt may include one or more different prompt units. This is schematically illustrated with respect to FIG. 4A, in which a prompt modifier 400A is combined with a prompt pill 402A to give a first prompt unit 404A. A second modifier 400B is combined with a second prompt pill 402B to give a second prompt unit 404. The two prompt units (and any suitable number of additional prompt units) may be combined to give an output prompt 406.

Turning now to FIG. 4B, as discussed above, different output prompts may be associated with different prompt domains. This is also referred to as prompt segmentation. As shown, a set of generated prompts 408 may be divided into various different prompt domains. In this example, this includes a “Create” domain 410, a “Review” domain 412, and an “Insight” domain 414.

FIG. 4C illustrates an example grounding process for a machine learning model 416. In this manner, various types of data may be input to the machine learning model to improve its ability to output relevant output prompts. In the example of FIG. 4C, this includes the prompt segmentation paradigm discussed above (e.g., prompts are divided into two or more distinct domains), the prompt structure paradigm discussed above (e.g., prompts are made from one or more prompt units, each of which includes a pill and a modifier), as well as user profiling data 422 (e.g., user identity, access history, access permissions), document state and access data 424 (e.g., whether the document is being edited or reviewed, when the document was edited last, when the document was accessed last), and a prompt history 426 (e.g., a history of other prompts generated for the same user, and/or for other users accessing the same document).

FIG. 4D schematically illustrates additional types of data that may be input into machine learning model 416 to influence the candidate prompts output by the model. As shown, this includes document state parameters, such as indications of whether the document is empty 428 (e.g., newly-created), in-progress 430 (e.g., a user is actively adding additional content to the document), and complete 432. Additionally, the machine learning model may receive one or more document interaction parameters, such as indications of a selected tool 440, any selected content 442 within the document, a current cursor position 444, a user viewport 446, any changes 448 applied to the document content, a history of prompts 450 applied to the document, a history of prompts 452 generated for the document, and any comments 454 applied to the document by one or more users. Additionally, the machine learning model may receive various types of feedback from the user in response to generated prompts. This may include an indication 456 of whether a prompt has been applied, an indication 458 of whether the system's response was refreshed or regenerated by the user, scoring feedback 460 (e.g., up-votes or down-votes), an indication 462 of whether a prompt was dismissed without being applied, and an indication 464 of whether a prompt was bookmarked for later use. The machine learning model may generate output prompts 466 based on any or all of these factors and indications, as well as any suitable types of data not explicitly described herein. Furthermore, in some cases, any or all of the information shown in FIG. 4D may be continuously provided to the machine learning model as such information changes and/or becomes available, allowing for dynamic updates to prompt generation over time.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 5 schematically shows a simplified representation of a computing system 500 configured to provide any to all of the compute functionality described herein. Computing system 500 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 500 includes a logic subsystem 502 and a storage subsystem 504. Computing system 500 may optionally include a display subsystem 506, input subsystem 508, communication subsystem 510, and/or other subsystems not shown in FIG. 5.

Logic subsystem 502 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem may optionally be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 504 includes one or more physical devices configured to temporarily and/or permanently hold computer information such as data and instructions executable by the logic subsystem. When the storage subsystem includes two or more devices, the devices may be collocated and/or remotely located. Storage subsystem 504 may include volatile, nonvolatile, dynamic, static, read/write, read-only, random-access, sequential-access, location-addressable, file-addressable, and/or content-addressable devices. Storage subsystem 504 may include removable and/or built-in devices. When the logic subsystem executes instructions, the state of storage subsystem 504 may be transformed—e.g., to hold different data.

Aspects of logic subsystem 502 and storage subsystem 504 may be integrated together into one or more hardware-logic components. Such hardware-logic components may include program-and application-specific integrated circuits (PASIC/ASICs), program-and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

Language models may utilize vocabulary features to guide sampling/searching for words for recognition of speech. For example, a language model may be at least partially defined by a statistical distribution of words or other vocabulary features. For example, a language model may be defined by a statistical distribution of n-grams, defining transition probabilities between candidate words according to vocabulary statistics. The language model may be further based on any other appropriate statistical features, and/or results of processing the statistical features with one or more machine learning and/or statistical algorithms (e.g., confidence values resulting from such processing). In some examples, a statistical model may constrain what words may be recognized for an audio signal, e.g., based on an assumption that words in the audio signal come from a particular vocabulary.

Alternately or additionally, the language model may be based on one or more neural networks previously trained to represent audio inputs and words in a shared latent space, e.g., a vector space learned by one or more audio and/or word models (e.g., wav2letter and/or word2vec). Accordingly, finding a candidate word may include searching the shared latent space based on a vector encoded by the audio model for an audio input, in order to find a candidate word vector for decoding with the word model. The shared latent space may be utilized to assess, for one or more candidate words, a confidence that the candidate word is featured in the speech audio.

The language model may be used in conjunction with an acoustical model configured to assess, for a candidate word and an audio signal, a confidence that the candidate word is included in speech audio in the audio signal based on acoustical features of the word (e.g., mel-frequency cepstral coefficients, formants, etc.). Optionally, in some examples, the language model may incorporate the acoustical model (e.g., assessment and/or training of the language model may be based on the acoustical model). The acoustical model defines a mapping between acoustic signals and basic sound units such as phonemes, e.g., based on labelled speech audio. The acoustical model may be based on any suitable combination of state-of-the-art or future machine learning (ML) and/or artificial intelligence (AI) models, for example: deep neural networks (e.g., long short-term memory, temporal convolutional neural network, restricted Boltzmann machine, deep belief network), hidden Markov models (HMM), conditional random fields (CRF) and/or Markov random fields, Gaussian mixture models, and/or other graphical models (e.g., deep Bayesian network). Audio signals to be processed with the acoustic model may be pre-processed in any suitable manner, e.g., encoding at any suitable sampling rate, Fourier transform, band-pass filters, etc. The acoustical model may be trained to recognize the mapping between acoustic signals and sound units based on training with labelled audio data. For example, the acoustical model may be trained based on labelled audio data comprising speech audio and corrected text, in order to learn the mapping between the speech audio signals and sound units denoted by the corrected text. Accordingly, the acoustical model may be continually improved to improve its utility for correctly recognizing speech audio.

In some examples, in addition to statistical models, neural networks, and/or acoustical models, the language model may incorporate any suitable graphical model, e.g., a hidden Markov model (HMM) or a conditional random field (CRF). The graphical model may utilize statistical features (e.g., transition probabilities) and/or confidence values to determine a probability of recognizing a word, given the speech audio and/or other words recognized so far. Accordingly, the graphical model may utilize the statistical features, previously trained machine learning models, and/or acoustical models to define transition probabilities between states represented in the graphical model.

When included, display subsystem 506 may be used to present a visual representation of data held by storage subsystem 504. This visual representation may take the form of a graphical user interface (GUI). Display subsystem 506 may include one or more display devices utilizing virtually any type of technology. In some implementations, display subsystem may include one or more virtual-, augmented-, or mixed reality displays.

When included, input subsystem 508 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 510 may be configured to communicatively couple computing system 500 with one or more other computing devices. Communication subsystem 510 may include wired and/or wireless communication devices compatible with one or more different communication protocols. The communication subsystem may be configured for communication via personal-, local- and/or wide-area networks.

The methods and processes disclosed herein may be configured to give users and/or any other humans control over any private and/or potentially sensitive data. Whenever data is stored, accessed, and/or processed, the data may be handled in accordance with privacy and/or security standards. When user data is collected, users or other stakeholders may designate how the data is to be used and/or stored. Whenever user data is collected for any purpose, the user data may only be collected with the utmost respect for user privacy (e.g., user data may be collected only when the user owning the data provides affirmative consent, and/or the user owning the data may be notified whenever the user data is collected). If the data is to be released for access by anyone other than the user or used for any decision-making process, the user's consent may be collected before using and/or releasing the data. Users may opt-in and/or opt-out of data collection at any time. After data has been collected, users may issue a command to delete the data, and/or restrict access to the data. All potentially sensitive data optionally may be encrypted and/or, when feasible, anonymized, to further protect user privacy. Users may designate portions of data, metadata, or statistics/results of processing data for release to other parties, e.g., for further processing. Data that is private and/or confidential may be kept completely private, e.g., only decrypted temporarily for processing, or only decrypted for processing on a user device and otherwise stored in encrypted form. Users may hold and control encryption keys for the encrypted data. Alternately or additionally, users may designate a trusted third party to hold and control encryption keys for the encrypted data, e.g., so as to provide access to the data to the user according to a suitable authentication protocol.

When the methods and processes described herein incorporate ML and/or AI components, the ML and/or AI components may make decisions based at least partially on training of the components with regard to training data. Accordingly, the ML and/or AI components may be trained on diverse, representative datasets that include sufficient relevant data for diverse users and/or populations of users. In particular, training data sets may be inclusive with regard to different human individuals and groups, so that as ML and/or AI components are trained, their performance is improved with regard to the user experience of the users and/or populations of users.

ML and/or AI components may additionally be trained to make decisions so as to minimize potential bias towards human individuals and/or groups. For example, when AI systems are used to assess any qualitative and/or quantitative information about human individuals or groups, they may be trained so as to be invariant to differences between the individuals or groups that are not intended to be measured by the qualitative and/or quantitative assessment, e.g., so that any decisions are not influenced in an unintended fashion by differences among individuals and groups.

ML and/or AI components may be designed to provide context as to how they operate, so that implementers of ML and/or AI systems can be accountable for decisions/assessments made by the systems. For example, ML and/or AI systems may be configured for replicable behavior, e.g., when they make pseudo-random decisions, random seeds may be used and recorded to enable replicating the decisions later. As another example, data used for training and/or testing ML and/or AI systems may be curated and maintained to facilitate future investigation of the behavior of the ML and/or AI systems with regard to the data. Furthermore, ML and/or AI systems may be continually monitored to identify potential bias, errors, and/or unintended outcomes.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for dynamic prompt generation comprises: receiving document content data representing at least a portion of a digital document accessed by a user via a client computing device during a document access session; receiving one or more document context parameters relating to a context of the document access session; determining a current prompt domain that pertains to the document access session, wherein the current prompt domain is selected from two or more different prompt domains; receiving, from a prompt generation system, one or more candidate prompts specifying one or more respective machine learning (ML)-mediated document interaction operations that could be applied to the digital document during the document access session, wherein the one or more candidate prompts are generated based at least in part on the document content data, the one or more document context parameters, and the current prompt domain; displaying the one or more candidate prompts in a user interface (UI) used to display the digital document at the client computing device; receiving a user selection of a selected prompt of the one or more candidate prompts; and applying the one or more respective ML-mediated document interaction operations associated with the selected prompt to the digital document. In this example or any other example, the two or more different prompt domains include at least a first prompt domain associated with generation of new content for inclusion in the digital document, a second prompt domain associated with modification of existing content in the digital document, and a third prompt domain associated with summarizing the existing content of the digital document. In this example or any other example, the user interface includes two or more segmented controls corresponding to the two or more different prompt domains, and wherein the current prompt domain is selected through user selection of a corresponding segmented control. In this example or any other example, each of the two or more segmented controls is associated with a corresponding UI section of two or more UI sections, and wherein the candidate prompts are displayed in the corresponding UI section associated with the current prompt domain. In this example or any other example, the user selection of the selected prompt causes display of a prompt-specific interface window in the UI, the prompt-specific interface window including visual content related to application of the one or more respective ML-mediated document interaction operations to the digital document. In this example or any other example, a size and a position of the prompt-specific interface window are dynamically adjustable. In this example or any other example, the current prompt domain is automatically determined based at least in part on the document content data and the one or more document context parameters. In this example or any other example, the method further comprises extracting one or more extracted entities from the digital document, wherein the one or more extracted entities include at least one of names, dates, keywords, titles, and section headers in the digital document, and wherein the one or more candidate prompts are generated based at least in part on the one or more extracted entities. In this example or any other example, the one or more document context parameters include at least one of a current cursor position, a current selected tool, selected content within the digital document, a current user viewport in the UI, an edit history of the digital document, access permissions associated with the user, and a history of previous candidate prompts selected for the digital document. In this example or any other example, the method further comprises receiving, from the prompt generation system, one or more updated candidate prompts that are generated as the document content data changes during the document access session. In this example or any other example, the method further comprises receiving user feedback directed at the one or more candidate prompts, and subsequently receiving a second set of one or more candidate prompts from the prompt generation system, wherein the second set of one or more candidate prompts are generated based at least in part on the user feedback. In this example or any other example, the prompt generation system is implemented by a server computing system communicatively coupled with the client computing device via a computer network.

In an example, a computing device comprises: a logic subsystem; and a storage subsystem holding instructions executable by the logic subsystem to: receive document content data representing at least a portion of a digital document accessed by a user via the computing device during a document access session; receive one or more document context parameters relating to a context of the document access session; determine a current prompt domain that pertains to the document access session, wherein the current prompt domain is selected from two or more different prompt domains; receive, from a prompt generation system, one or more candidate prompts specifying one or more respective machine learning (ML)-mediated document interaction operations that could be applied to the digital document during the document access session, wherein the one or more candidate prompts are generated based at least in part on the document content data, the one or more document context parameters, and the current prompt domain; display the one or more candidate prompts in a user interface (UI) used to display the digital document; receive a user selection of a selected prompt of the one or more candidate prompts; and apply the one or more respective ML-mediated document interaction operations associated with the selected prompt to the digital document. In this example or any other example, the two or more different prompt domains include at least a first prompt domain associated with generation of new content for inclusion in the digital document, a second prompt domain associated with modification of existing content in the digital document, and a third prompt domain associated with summarizing the existing content of the digital document. In this example or any other example, the user interface includes two or more segmented controls corresponding to the two or more different prompt domains, and wherein the current prompt domain is selected through user selection of a corresponding segmented control. In this example or any other example, each of the two or more segmented controls is associated with a corresponding UI section of two or more UI sections, and wherein the candidate prompts are displayed in the corresponding UI section associated with the current prompt domain. In this example or any other example, the user selection of the selected prompt causes display of a prompt-specific interface window in the UI, the prompt-specific interface window including visual content related to application of the one or more respective ML-mediated document interaction operations to the digital document. In this example or any other example, the instructions are further executable to receive, from the prompt generation system, one or more updated candidate prompts that are generated as the document content data changes during the document access session.

In an example, a method for dynamic prompt generation comprises: receiving document content data representing at least a portion of a digital document accessed by a user via a client computing device during a document access session; receiving one or more document context parameters relating to a context of the document access session; receiving a user selection of a current prompt domain from two or more different prompt domains, wherein the user selection is directed to a segmented control displayed in a user interface (UI) of the client computing device, the segmented control corresponding to the current prompt domain; receiving, from a prompt generation system, one or more candidate prompts specifying one or more respective machine learning (ML)-mediated document interaction operations that could be applied to the digital document during the document access session, wherein the one or more candidate prompts are generated based at least in part on the document content data, the one or more document context parameters, and the current prompt domain; displaying the one or more candidate prompts in the UI; receiving a user selection of a selected prompt of the one or more candidate prompts; applying the one or more respective ML-mediated document interaction operations associated with the selected prompt to the digital document; receiving user feedback directed to the one or more candidate prompts; and receiving, from the prompt generation system, a second set of one or more candidate prompts for the digital document generated based at least in part on the user feedback. In this example or any other example, the method further comprises receiving, from the prompt generation system, one or more updated candidate prompts that are generated as the document content data changes during the document access session.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for dynamic prompt generation, the method comprising:
receiving document content data representing at least a portion of a digital document accessed by a user via a client computing device during a document access session;
receiving one or more document context parameters relating to a context of the document access session;
determining a current prompt domain that pertains to the document access session, wherein the current prompt domain is selected from two or more different prompt domains;
receiving, from a prompt generation system, one or more candidate prompts specifying one or more respective machine learning (ML)-mediated document interaction operations that could be applied to the digital document during the document access session, wherein the one or more candidate prompts are generated based at least in part on the document content data, the one or more document context parameters, and the current prompt domain;
displaying the one or more candidate prompts in a user interface (UI) used to display the digital document at the client computing device;
receiving a user selection of a selected prompt of the one or more candidate prompts; and
applying the one or more respective ML-mediated document interaction operations associated with the selected prompt to the digital document.

2. The method of claim 1, wherein the two or more different prompt domains include at least a first prompt domain associated with generation of new content for inclusion in the digital document, a second prompt domain associated with modification of existing content in the digital document, and a third prompt domain associated with summarizing the existing content of the digital document.

3. The method of claim 1, wherein the user interface includes two or more segmented controls corresponding to the two or more different prompt domains, and wherein the current prompt domain is selected through user selection of a corresponding segmented control.

4. The method of claim 3, wherein each of the two or more segmented controls is associated with a corresponding UI section of two or more UI sections, and wherein the candidate prompts are displayed in the corresponding UI section associated with the current prompt domain.

5. The method of claim 1, wherein the user selection of the selected prompt causes display of a prompt-specific interface window in the UI, the prompt-specific interface window including visual content related to application of the one or more respective ML-mediated document interaction operations to the digital document.

6. The method of claim 5, wherein a size and a position of the prompt-specific interface window are dynamically adjustable.

7. The method of claim 1, wherein the current prompt domain is automatically determined based at least in part on the document content data and the one or more document context parameters.

8. The method of claim 1, further comprising extracting one or more extracted entities from the digital document, wherein the one or more extracted entities include at least one of names, dates, keywords, titles, and section headers in the digital document, and wherein the one or more candidate prompts are generated based at least in part on the one or more extracted entities.

9. The method of claim 1, wherein the one or more document context parameters include at least one of a current cursor position, a current selected tool, selected content within the digital document, a current user viewport in the UI, an edit history of the digital document, access permissions associated with the user, and a history of previous candidate prompts selected for the digital document.

10. The method of claim 1, further comprising receiving, from the prompt generation system, one or more updated candidate prompts that are generated as the document content data changes during the document access session.

11. The method of claim 1, further comprising receiving user feedback directed at the one or more candidate prompts, and subsequently receiving a second set of one or more candidate prompts from the prompt generation system, wherein the second set of one or more candidate prompts are generated based at least in part on the user feedback.

12. The method of claim 1, wherein the prompt generation system is implemented by a server computing system communicatively coupled with the client computing device via a computer network.

13. A computing device comprising:
a logic subsystem; and
a storage subsystem holding instructions executable by the logic subsystem to:
receive document content data representing at least a portion of a digital document accessed by a user via the computing device during a document access session;
receive one or more document context parameters relating to a context of the document access session;
determine a current prompt domain that pertains to the document access session, wherein the current prompt domain is selected from two or more different prompt domains;
receive, from a prompt generation system, one or more candidate prompts specifying one or more respective machine learning (ML)-mediated document interaction operations that could be applied to the digital document during the document access session, wherein the one or more candidate prompts are generated based at least in part on the document content data, the one or more document context parameters, and the current prompt domain;
display the one or more candidate prompts in a user interface (UI) used to display the digital document;
receive a user selection of a selected prompt of the one or more candidate prompts; and
apply the one or more respective ML-mediated document interaction operations associated with the selected prompt to the digital document.

14. The computing device of claim 13, wherein the two or more different prompt domains include at least a first prompt domain associated with generation of new content for inclusion in the digital document, a second prompt domain associated with modification of existing content in the digital document, and a third prompt domain associated with summarizing the existing content of the digital document.

15. The computing device of claim 13, wherein the user interface includes two or more segmented controls corresponding to the two or more different prompt domains, and wherein the current prompt domain is selected through user selection of a corresponding segmented control.

16. The computing device of claim 15, wherein each of the two or more segmented controls is associated with a corresponding UI section of two or more UI sections, and wherein the candidate prompts are displayed in the corresponding UI section associated with the current prompt domain.

17. The computing device of claim 13, wherein the user selection of the selected prompt causes display of a prompt-specific interface window in the UI, the prompt-specific interface window including visual content related to application of the one or more respective ML-mediated document interaction operations to the digital document.

18. The computing device of claim 13, wherein the instructions are further executable to receive, from the prompt generation system, one or more updated candidate prompts that are generated as the document content data changes during the document access session.

19. A method for dynamic prompt generation, the method comprising:
receiving document content data representing at least a portion of a digital document accessed by a user via a client computing device during a document access session;
receiving one or more document context parameters relating to a context of the document access session;
receiving a user selection of a current prompt domain from two or more different prompt domains, wherein the user selection is directed to a segmented control displayed in a user interface (UI) of the client computing device, the segmented control corresponding to the current prompt domain;
receiving, from a prompt generation system, one or more candidate prompts specifying one or more respective machine learning (ML)-mediated document interaction operations that could be applied to the digital document during the document access session, wherein the one or more candidate prompts are generated based at least in part on the document content data, the one or more document context parameters, and the current prompt domain;
displaying the one or more candidate prompts in the UI;
receiving a user selection of a selected prompt of the one or more candidate prompts;
applying the one or more respective ML-mediated document interaction operations associated with the selected prompt to the digital document;
receiving user feedback directed to the one or more candidate prompts; and
receiving, from the prompt generation system, a second set of one or more candidate prompts for the digital document generated based at least in part on the user feedback.

20. The method of claim 19, further comprising receiving, from the prompt generation system, one or more updated candidate prompts that are generated as the document content data changes during the document access session.
